(19) United States
(12) Patent Application Publication
(10) Pub. No.: US 2025/0380682 A1
(43) Pub. Date: Dec. 18, 2025

(54) THROWABLE ANIMAL REPELLANT DISPENSING DEVICE

(71) Applicant: Adam D. Trina, Missoula, MT (US)

(72) Inventor: Adam D. Trina, Missoula, MT (US)

(21) Appl. No.: 19/236,458

(22) Filed: Jun. 12, 2025

Related U.S. Application Data
(60) Provisional application No. 63/659,235, filed on Jun. 12, 2024.

(51) Int. Cl. A01M 29/12; F41H 9/00

(52) U.S. Cl. CPC A01M 29/12; F41H 9/00

(57) ABSTRACT

A throwable animal repellant dispersing device with a receptacle containing animal repellant, a carbon dioxide or other similar pressurization cartridge contained within the receptacle, and a detonation apparatus with safety features to prevent accidental activation of the device, the receptacle being designed with a series of ridges and/or segments that operate to rupture in a manner such that the animal repellant contained within is dispersed relatively evenly amongst the associated deployment area, the safety features of the detonation apparatus including a lever to prevent a spring-loaded hammer from striking a detonation pin, the lever being held in place by two safety pins arranged substantially perpendicular to and interconnected with one another.

### FIELD OF THE INVENTION

The present invention relates to a bear repellant device that a user can throw, the device then employing a timed release and dispersion of bear repellant such as bear spray, pepper spray, or the like.

### BACKGROUND OF THE INVENTION

Outdoor leisure activities are highly popular amongst western populations. Thousands enjoy activities such as running, swimming, surfing, boating, hiking, biking, skiing, skating, and the like. Each such activity comes with its own risks, but for many those risks are outweighed by the enjoyment that comes from experiencing the outdoors.

Nevertheless, wise participants in such outdoor activities take certain precautions to mitigate those risks: skiers and bikers wear helmets, boaters and swimmers make sure floatation devices are readily available, surfers avoid certain waters and times of day when hazards are more likely to present themselves.

For outdoor adventurers and hikers, encountering wild animals can present both a risk and a form of enjoyment. However, some wild animal encounters can turn dangerous quickly, such as bear, mountain lion, and other predatory animal encounters. For this reason, many outdoorsmen ensure that they are equipped with animal repellant devices, such as bear spray and the like. These products mitigate the risk of wild animal encounters and provide reassurance for those enjoying remote outdoor locations without other weapons or forms of defense.

Typically, bear spray products comprise a receptacle containing compressed fluids, typically in gas form, including some form and amount of bear or other animal repellant. The user of such products must pull them out of wherever they are stored, release any accidental discharge features, and then point them at the target wild animal before releasing the repellant, typically using a trigger of some form. While these devices can certainly be effective in some scenarios, they suffer from several drawbacks as well.

First, the steps required before deployment of the repellant take time, which is often in short supply during a wild animal encounter where the repellant is needed. Furthermore, they require precise and measured actions by the user, who is often highly frightened and under substantial stress. These conditions make proper deployment of the repellant difficult, particularly for those who's performance of tasks suffer during high-stress environments.

And even for those who do not, the classic bear spray product has a limited range, typically of around 30 feet. This limitation means that even a user who is prepared to deploy the repellant must wait until an—often charging—wild animal is less than 10 yards away before activating the device and deploying the repellant. As one might imagine, and as anyone who has had the unfortunate experience of having to manage such a scenario, 10 yards is a very short distance when facing an oncoming bear or other wild predator. And if the device should malfunction, or if the user forgot to release an accidental discharge safety feature, etc., there is no time for a second chance.

Accordingly, there is a need in the outdoorsman safety industry for an animal repellant device capable of deployment at greater distances that is safe, reliable, and effective. There is also a need for such a device that can be deployed before a scenario turns into a high stress, high stakes outcome, where the device is all that stands between the user and a violent encounter with a charging wild animal predator.

### SUMMARY OF THE INVENTION

It is hence an object of the present invention to provide an animal repellant dispensing device that is easy to use, employs common-sense safety features, and can be deployed over large distances. It is further an object of the present invention to provide such an animal repellant dispensing device that can be deployed without ongoing operation by the user. It is also an object of the present invention to provide an animal repellant dispensing device that can be thrown to a location and dispersed among an area to forestall a wild animal encounter before it turns dangerous and potentially deadly.

To achieve these and other objectives, the throwable animal repellant dispersing device of the present invention includes a receptacle containing animal repellant, which may be pre-pressurized in some preferable embodiments, a detonation apparatus with safety features to prevent accidental activation of the device, and a carbon dioxide or other similar cartridge for increasing the pressure within the receptacle to the point of rupture. The receptacle is preferably designed with a series of ridges and/or segments that operate to rupture in a manner such that the animal repellant contained within is dispersed relatively evenly amongst the associated deployment area.

The receptacle thus preferably features one or more ridges, preferably running lengthwise along the receptacle's side substantially from top to bottom, the ridges being intended to weaken portions of the wall in a relatively uniform manner such that no single location is likely to rupture alone. In some preferable embodiments, the receptacle may also or alternatively employ a segmented design, similar to a honeycomb, pineapple, or classic grenade body design, which provides weakened wall locations where the material is thinner between the segments, as those of skill in the art will recognize and understand.

The receptacle is preferably connected with the detonation apparatus using known techniques, such as a threaded fastening element in some preferable embodiments. The threaded fastening element or other know connection techniques are preferably disposed at or near the upper end of the receptacle, and the detonation apparatus is preferably disposed at the upper end of the receptacle when the animal repellant dispensing device of the present invention is assembled for use.

The carbon dioxide cartridge or other similar pressurization cartridge is disposed within the receptacle when the animal repellant dispensing device is assembled for use. The detonation apparatus operates to puncture the pressurization cartridge upon activation, releasing the carbon dioxide or other pressurized fluid contained therein into the receptacle, increasing the pressure within the receptacle to the point of rupture and dispensing the pressurized animal repellant contained therein.

In some preferable embodiments, the animal repellant dispensing device of the present invention employs a cartridge housing that fits around and contains the pressurization cartridge, the cartridge housing preferably comprising one or more apertures that facilitate the release of the pressurized fluid from the pressurization cartridge uniformly within the receptacle. The cartridge housing preferably includes one or more small holes sized and distributed to slowly distribute the pressurized fluid released from the pressurization cartridge into the surrounding receptacle. The size of the aperture is crucial as it, in conjunction with the thickness of the walls of the cartridge housing, determines the time-delay after the hammer penetrates the pressurization cartridge before release of all the pressurized fluid into the receptacle. The cartridge housing and the pressurization cartridge are together preferably disposed within the receptacle when the animal repellant dispensing device is assembled for use, in such preferable embodiments.

The detonation apparatus combines a receptacle connection part with a threaded portion counter-threaded to the threaded fastening element of the receptacle, in preferable embodiments, a cartridge housing connection part also preferably employing a threaded portion counter-threaded to the threaded fastening element of the cartridge housing, and a trigger assembly that facilitates the puncturing of the pressurization cartridge and release of the pressurized fluid contained therein into the receptacle.

The trigger assembly includes, in preferable embodiments, a spring-loaded hammer operable to rotate and strike a detonation pin that travels toward and penetrates the pressurization cartridge to release the pressurized fluid contained therein. The detonation pin and spring-loaded hammer are preferably returnable to their non-activated position after use of the trigger assembly in connection with detonating the throwable animal repellant dispersing device of the present invention, making the detonation apparatus, and the trigger assembly specifically, reusable, as those of skill in the art will recognize.

The trigger assembly also includes, in preferable embodiments, a lever or “spoon” rotate-ably affixed to the remainder of the trigger assembly. The lever holds the spring-loaded hammer in place and prevents it from rotating when the animal repellant dispersing device is assembled for use. Once the lever is released, the spring-loaded hammer is free to rotate and strike the detonation pin to release the pressurized fluid from the pressurization cartridge and, ultimately, the animal repellant from the receptacle.

Preferable embodiments of the trigger assembly of the throwable animal repellant dispersing device of the present invention include an accidental detonation safety feature comprising at least two safety pins. The first of the two safety pins is inserted through one or more apertures on the lever and one or more matching apertures on a hammer housing surrounding and housing the spring-loaded hammer and detonation pin. The first safety pin is held in place by the hammer housing, preferably just above the spring-loaded hammer, preventing the spring-loaded hammer from rotating and striking the detonation pin even if the lever is rotated to its open position. In preferable embodiments, the first safety pin can hence operate to prevent both the spring-loaded hammer and the lever from rotating/releasing or it can operate to prevent the spring-loaded hammer from rotating and allow the lever to rotate freely.

Preferable embodiments of the first safety pin include a shaft of sufficient length to extend through the one or more apertures in each of the lever and the hammer housing, a handle portion at one end to facilitate the user grasping and pulling the first safety pin, and a rubber or other similar material plug removably attached to the other end to prevent the pin from being pulled inadvertently. The handle portion may comprise a ring or metal loop, in some preferable embodiments. The first safety pin also preferably includes an eyelet located substantially centrally along the shaft of the shaft, the eyelet being sized and position to line up with one or more apertures in the lever and one or more apertures in the hammer housing and to receive the second safety pin threaded therethrough.

The second safety pin likewise comprises, in preferable embodiments, a shaft of sufficient length to extend through the one or more apertures in each of the lever and the hammer housing as well as the eyelet in the first safety pin, a handle portion at one end to facilitate the user grasping and pulling the second safety pin, and a rubber or other similar material plug removably attached to the other end to prevent the pin from being pulled inadvertently. The second safety pin may include an eyelet of its own, in some preferable embodiments, operable to discourage inadvertent pulling of the second safety pin in addition to the rubber plug.

The second safety pin is disposed substantially perpendicular to the first safety pin, in preferable embodiments, preventing the removal of the first safety pin without first removing the second safety pin and adding a measure of redundancy to the accidental detonation safety features throwable animal repellant dispersing device of the present invention.

During assembly and preparation of the animal repellant dispersing device for use, the detonation apparatus is prepared for activation by rotating the spring-loaded hammer into the non-activated position and rotating the lever down over the top of the spring-loaded hammer and into its closed position. This process is preferably performed at the time of manufacture, rather than by the end user. Next, the first safety pin is threaded through the one or more apertures in both the lever and the hammer housing and attaches the rubber plug to the distal end of the first safety pin's shaft, placing the detonation apparatus into an active mode retained by the accidental detonation safety features.

The second safety pin is then threaded through the one or more apertures in both the lever and the hammer housing as well as the eyelet in the first safety pin, in preferable embodiments, and the rubber plug is placed on the distal end of the second safety pin's shaft, adding a redundant safety mechanism to prevent inadvertent activation of the detonation apparatus. Finally, the detonation pin is mechanically biased into the non-activated position such that, when the spring-loaded hammer is released, it will strike the detonation pin and drive the detonation pin into the pressurization cartridge.

The pressurization cartridge is next placed within the cartridge housing, in preferable embodiments, and the cartridge housing is attached to the detonation apparatus using the threaded connection means or other connection means, as will be known to those of skill in the art. The detonation apparatus is then attached to the receptacle containing animal repellant, disposing the pressurization cartridge and cartridge housing substantially centrally within the receptacle.

To operate the preferable embodiments of the present invention described above, the user pulls the second safety pin, which is preferably held in place by both the eyelet of the second safety pin and the rubber plug attached to the distal end of the second safety pin's shaft, by grasping the second safety pin's handle portion and drawing it out of the eyelet of the first safety pin and the one or more apertures of both the hammer housing and the lever. The removal of the second safety pin allows the removal of the first safety pin, which is likewise held in place, at least in part in preferable embodiments, by both the eyelet of the first safety pin and the rubber plug attached to the distal end of the first safety pin's shaft.

With both the first and second safety pins removed, the lever is now free to rotate up and away from the spring-loaded hammer, which it will do automatically due to the force the spring-loaded hammer places upon the lever once the user releases his or her grip on the lever. With the lever out of the way, the spring-loaded hammer is free to rotate and strike the detonation pin, which is thereby driven into the connected pressurization cartridge. The pressurized fluid is thus released from the pressurization cartridge into the cartridge housing, which holds the pressurized air while it is slowly released through small aperture(s) into the receptacle to regulate the delay time.

When the user throws the device, the lever will be released allowing the hammer to rotate and strike the gas cartridge. After a short period of time, based on the size of the one or more apertures of the inner cartridge housing, the receptacle reaches its fluid containing capacity and ruptures, releasing the animal repellant in the general area it resides. During the time period between the release of the pressurized fluid from the pressurization cartridge and the rupture of the receptacle, the user may throw the device or drop and back/run away, if he or she has not already thrown or dropped the device. The release of the animal repellant will then deter an oncoming wild animal or otherwise create a barrier between such a wild animal and the user of the device. Preferable embodiments of the present invention also release a loud noise, reaching around 30 decibels or louder, which acts as a further deterrent to any oncoming wild animal.

As those skilled in the art will appreciate, the present invention is not limited to the embodiments and arrangements described above. Other objects of the present invention and its particular features and advantages will become more apparent from consideration of the following drawings and detailed description of the invention.

### BRIEF DESCRIPTION OF THE DRAWINGS

FIG. 1 depicts a perspective view showing the top of the receptacle of the throwable animal repellant dispersing device according to exemplary embodiments of the present invention.

FIG. 2 depicts a perspective view showing the bottom of the receptacle of the throwable animal repellant dispersing device according to the exemplary embodiments of the present invention depicted in FIG. 1.

FIG. 3 depicts a perspective view showing a side of the receptacle of the throwable animal repellant dispersing device according to the exemplary embodiments of the present invention depicted in FIGS. 1-2.

FIG. 4 depicts an orthogonal view from a side of the receptacle of the throwable animal repellant dispersing device according to the exemplary embodiments of the present invention depicted in FIGS. 1-3.

FIG. 5 depicts an orthogonal view from the top of the receptacle of the throwable animal repellant dispersing device according to the exemplary embodiments of the present invention depicted in FIGS. 1-4.

FIG. 6 depicts an orthogonal view from the bottom of the receptacle of the throwable animal repellant dispersing device according to the exemplary embodiments of the present invention depicted in FIGS. 1-5.

FIG. 7 depicts a cross-sectional perspective view showing the receptacle of the throwable animal repellant dispersing device according to the exemplary embodiments of the present invention depicted in FIGS. 1-6.

FIG. 8 depicts a cross-sectional orthogonal view from a side of the receptacle of the throwable animal repellant dispersing device according to the exemplary embodiments of the present invention depicted in FIGS. 1-7.

FIG. 9 depicts a cross-sectional perspective view showing a portion of the bottom end of the receptacle of the throwable animal repellant dispersing device according to the exemplary embodiments of the present invention depicted in FIGS. 1-8.

FIG. 10 depicts a cross-sectional perspective view showing a portion of the top end of the receptacle of the throwable animal repellant dispersing device according to the exemplary embodiments of the present invention depicted in FIGS. 1-9.

FIG. 11A depicts an assembly view of the throwable animal repellant dispersing device according to the exemplary embodiments of the present invention depicted in FIGS. 1-10.

FIG. 11B depicts an assembly view of a pressurization cartridge and a cartridge housing of the throwable animal repellant dispersing device according to the exemplary embodiments of the present invention depicted in FIGS. 1-10 and 11A.

FIG. 11C depicts a perspective view of the throwable animal repellant dispersing device according to the exemplary embodiments of the present invention depicted in FIGS. 1-10 and 11A-B.

FIG. 11D depicts an orthogonal view from the side of the throwable animal repellant dispersing device according to the exemplary embodiments of the present invention depicted in FIGS. 1-10 and 11A-C.

FIG. 12A depicts a perspective view of the throwable animal repellant dispersing device according to the exemplary embodiments of the present invention depicted in FIGS. 1-11.

FIG. 12B depicts a perspective view of the throwable animal repellant dispersing device according to the exemplary embodiments of the present invention depicted in FIGS. 1-11 and 12A.

FIG. 12C depicts an orthogonal view from the side of a first safety pin of the throwable animal repellant dispersing device according to the exemplary embodiments of the present invention depicted in FIGS. 1-11 and 12A-B.

FIG. 12D depicts an orthogonal view from the side of a second safety pin of the throwable animal repellant dispersing device according to the exemplary embodiments of the present invention depicted in FIGS. 1-11 and 12A-C.

FIG. 13 depicts a partial perspective view of the detonation apparatus of the throwable animal repellant dispersing device according to the exemplary embodiments of the present invention depicted in FIGS. 1-12.

FIG. 14 depicts a partial perspective view of the detonation apparatus of the throwable animal repellant dispersing device according to the exemplary embodiments of the present invention depicted in FIGS. 1-13.

### DETAILED DESCRIPTION OF THE INVENTION

The following detailed description illustrates the technology by way of example, not by way of limitation of the principles of the invention. This description will enable one skilled in the art to make and use the technology, and describes several embodiments, adaptations, variations, alternatives and uses of the invention, including what is presently believed to be the best mode of carrying out the invention. One skilled in the art will recognize alternative variations and arrangements, and the present technology is not limited to those embodiments described hereafter.

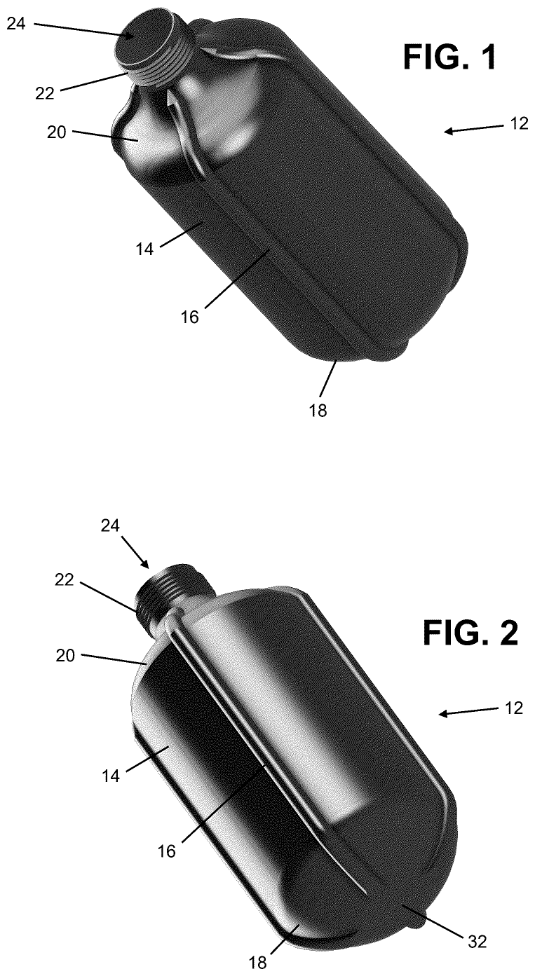

Referring first to FIG. 1, preferable embodiments of the receptacle 12 of the throwable animal repellant dispersing device 10 of the present invention is shown. The receptacle 12 is preferably substantially cylindrical in shape, as depicted, to facilitate the uniform distribution of the animal repellant in the vicinity of the device 10 when the receptacle 12 ruptures. Some preferable embodiments employ a smooth receptacle wall 14 in between one or more lengthwise ribs 16, as depicted, while others employ a honeycomb or pineapple type wall with small sections separated by thinner rupture lines more likely to rupture during use. Those of skill in the art will understand the advantages of adding the honeycomb or pineapple style wall to the design as depicted.

The one or more lengthwise ribs 16 preferably extend from at least a portion of the curved bottom wall 18 of the receptacle, along the entire length of the sidewall 14, and along at least a portion of the curved top wall 20 to meet the threaded fastening element 22, as depicted in FIG. 1. The threaded fastening element 22 may be replaced by other known connection features, as will be known to those of skill in the art, so long as they are sufficiently robust so as to ensure the receptacle 12 does not separate from the detonation apparatus 50 when the receptacle is filling with pressurized fluid before it ruptures during use.

The one or more lengthwise ribs 16 provide additional rigidity to the portions of the substantially cylindrical sidewall 14 they cover. The preferable embodiment depicted in FIG. 1 employs 4 such lengthwise ribs 16, although more or less may be included in certain preferable embodiments, as those of skill in the art will recognize. The lengthwise ribs 16 provide additional rigidity such that the portions of the receptable's sidewall 14 between the lengthwise ribs 16 are more likely to rupture during deployment of the device, helping to ensure a more uniform disbursement of animal repellant during use.

The threaded fastening element 22 or other known connection feature preferably attaches directly to the detonation apparatus 50, and provides an opening 24, as depicted in FIG. 1, into which the pressurization cartridge 26 is inserted, along with any cartridge housing 28 employed in preferable embodiments of the present invention. With the pressurization cartridge 26 substantially centrally disposed within the receptacle 12, the pressurized fluid 30 is released from the pressurized cartridge 26 and associated cartridge housing 28 relatively uniformly within the receptacle 12, helping to facilitate the uniform rupture of the receptacle's sidewall 14 and the uniform disbursement of the animal repellant contained therein during deployment.

Referring now to FIG. 2, preferable embodiments of the receptacle 12 of the throwable animal repellant dispersing device 10 according to the present invention have a substantially cylindrical sidewall 14 and a substantially curved top 20 and bottom 18 end. The threaded fastening element 22 or other known connection features form the distal end of the curved top 20 while the distal end of the curved bottom wall 18 tapers into a flat section 32, in preferable embodiments, including those depicted in FIG. 2. The substantially flat apex 32 at the distal end of the curved bottom 18 facilitates standing the receptacle 12 on end when filling it with animal repellant, assembling and attaching the detonation apparatus 50, etc. As depicted, the one or more lengthwise ribs 16 also preferably taper down to nothing at the substantially flat apex 32, improving the stability of the receptacle 12 when stood on end.

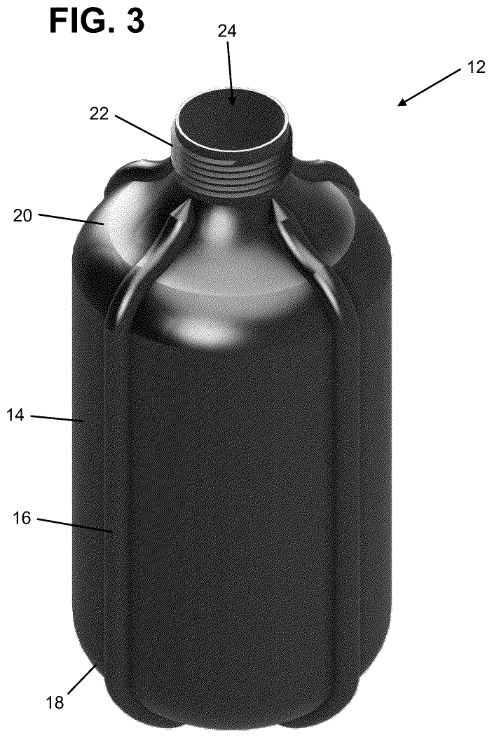

Referring next to FIG. 3, the one or more lengthwise ribs 16 of preferable embodiments of the receptacle 12 likewise taper down to nothing when they reach the threaded fastening element 22 or other known connection features at the distal end of the curved top wall 20, ensuring that the lengthwise ribs 16 do not interfere with connecting the receptacle 12 to the detonation apparatus 50. As those of skill in the art will recognize, a substantially cylindrical threaded fastening element 22 is preferable, although other cross-sectional shapes will be available as well, particularly in preferable embodiments where other connection features 22 are employed.

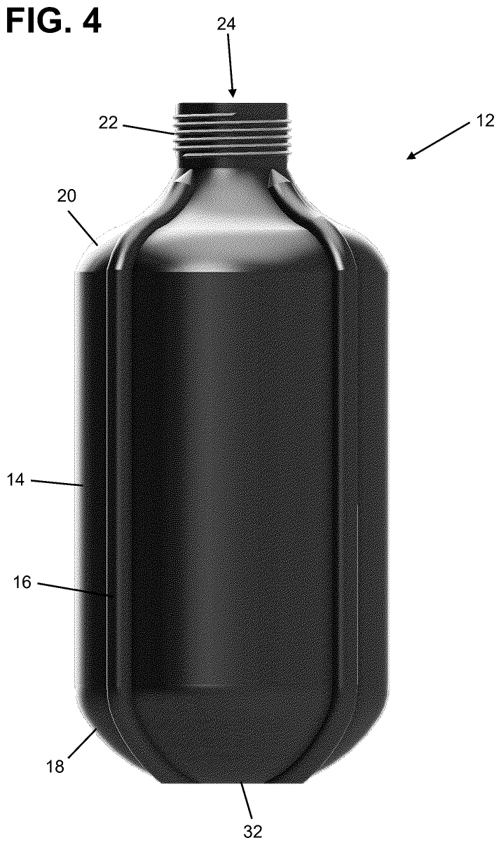

Referring now to FIG. 4, the threaded fastening element 22, curved top wall 20, substantially cylindrical sidewall 14 with one or more lengthwise ribs 16, curved bottom wall 18, and substantially flat apex 32 at the distal end of the curved bottom wall 18 are all visible, demonstrating preferable embodiments of the receptacle 12 of the throwable animal repellant dispersing device 10 according to the present invention. Upon puncture of the pressurization cartridge 26 inserted through the opening 24 in the threaded fastening element 22, the receptacle 12, already containing the animal repellant, begins to fill with the released pressurized CO2 or other fluid 30. The pressurized fluid 30 mixes with the animal repellant while the receptacle's 12 interior pressure increases to the point of rupture of the sidewall 14 between the lengthwise ribs 16 where the receptacle's walls 14 are designed to be weakest. Upon rupture, the animal repellant is released into the general area in a substantially uniform manner, driving off and/or deterring any wild animal present.

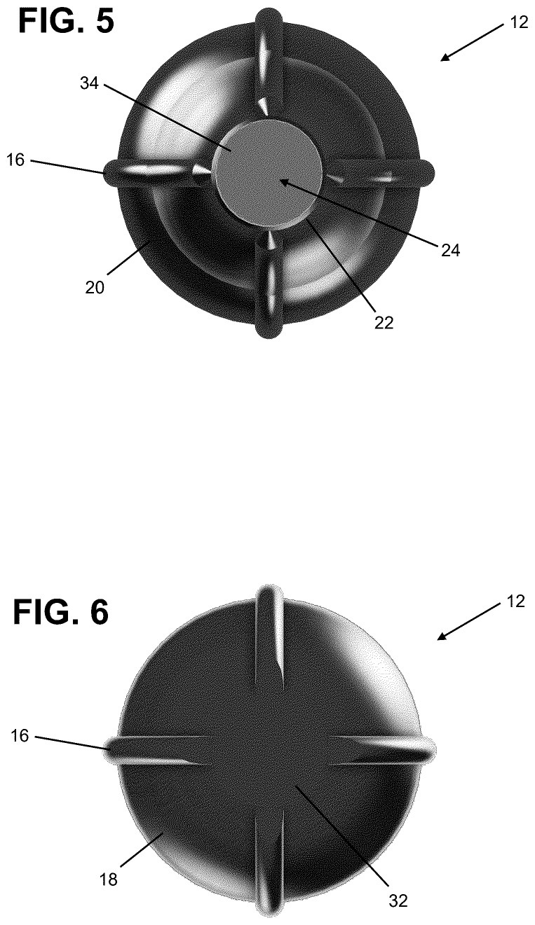

Preferable embodiments of the opening 24 in the threaded fastening element 22 or other connection features, located at the distal end of the curved top wall 20, along with the curved top wall 20 and one or more lengthwise ribs 16, are shown in FIG. 5, as is the interior 34 of the receptacle 12 where the animal repellant resides. FIG. 6 likewise shows preferable embodiments of the substantially flat apex 32, located at the distal end of the curved bottom wall 18, the curved bottom wall 18, and the one or more lengthwise ribs 16 tapering to nothing as they reach the substantially flat apex 32, forming a substantially flat bottom upon which the receptacle 12 can rest on end.

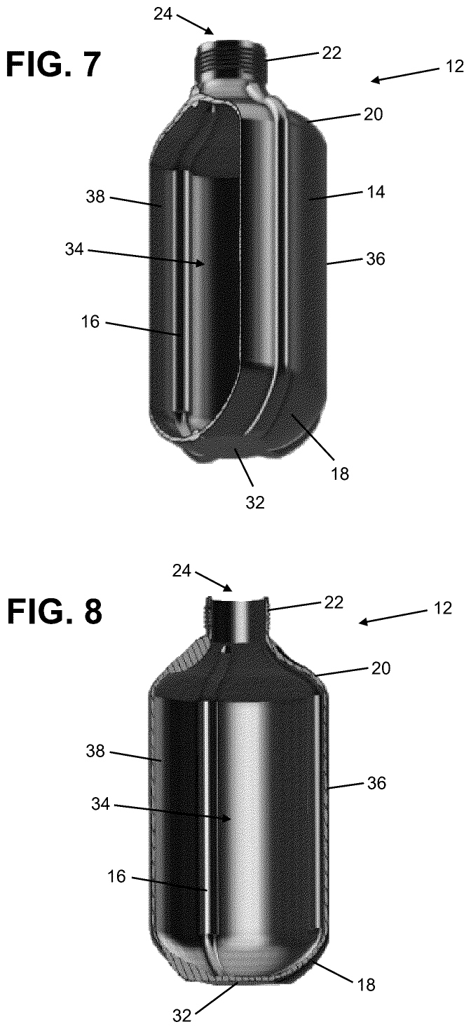

Referring now to FIGS. 7 and 8, as depicted, the one or more lengthwise ribs 16 preferably extend from both the exterior surface 36 and the interior surface 38 of the receptacle's top 20, bottom 18, and sidewall 14. This maximizes the strengthening functionality of the one or more lengthwise ribs 16 and provides standing rigidity for the receptacle 12. It also creates the added benefit of providing improved grip for a user who has activated the animal repellant dispersing device 10 and is preparing to throw it.

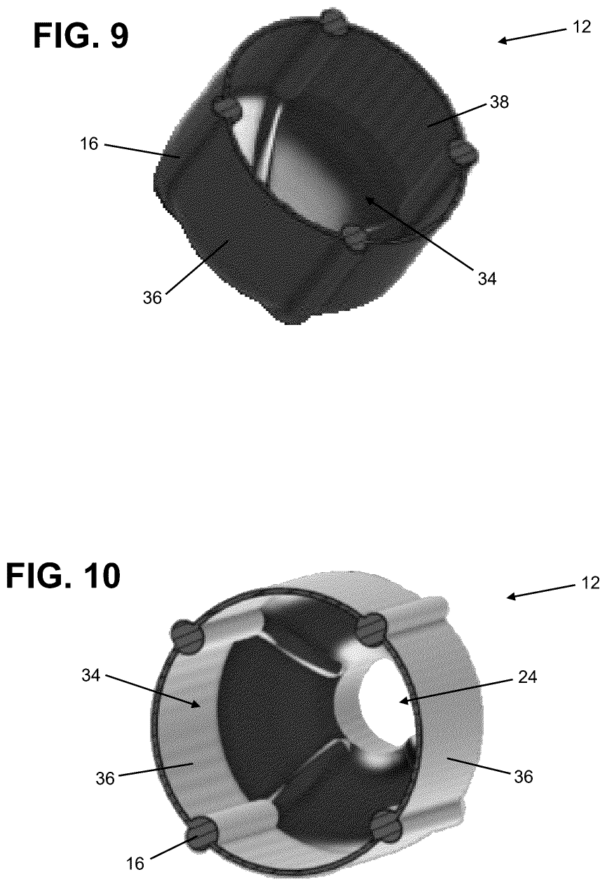

As visible in FIGS. 9 and 10, the one or more lengthwise ribs 16 themselves have a substantially circular cross-sectional shape, in preferable embodiments, which extends from the distal end of the curved top wall 20 where the threaded fastening element 22 or other connection features reside substantially uniformly all along the curved top wall 20, sidewall 14, and curved bottom wall 18 before tapering out as they reach the substantially flat apex 32 located at the distal end of the curved bottom wall 18. Preferable embodiments of the lengthwise ribs 16 are provided with uniform thickness and without imperfections to ensure no weak areas are created where the lengthwise rib 16 might rupture during deployment of the device 10.

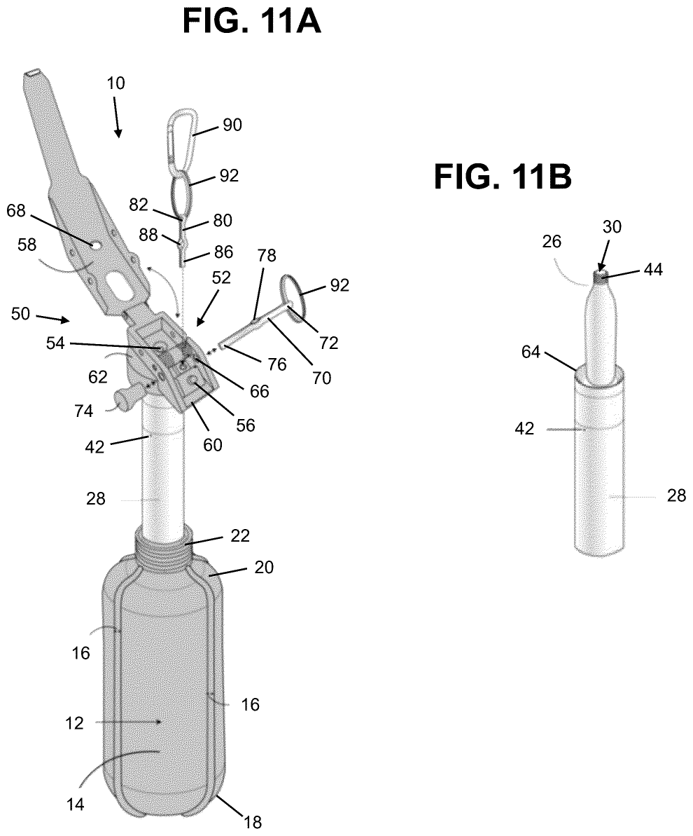

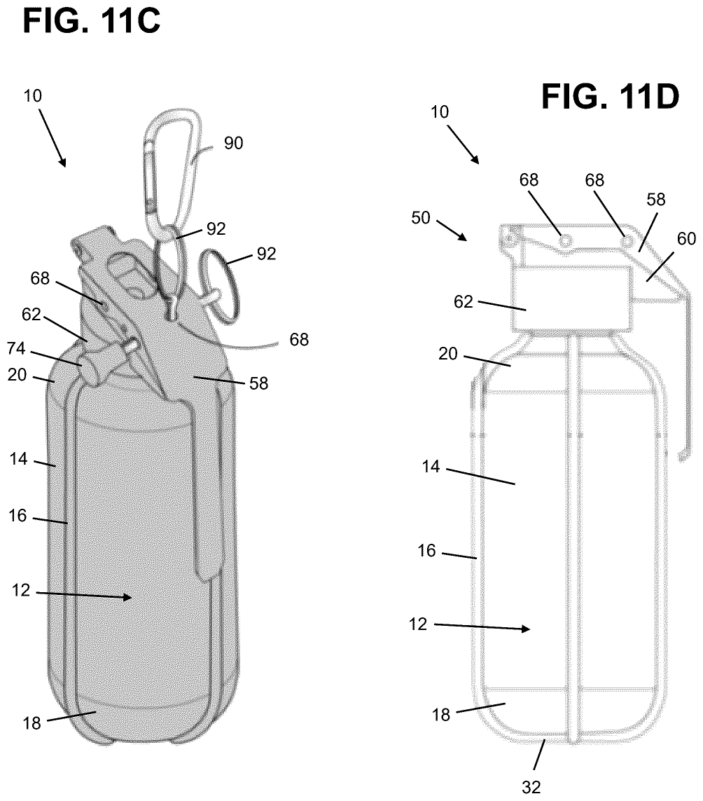

Referring now to FIG. 11, preferable embodiments of the throwable animal repellant dispersing device 10 according to the present invention are depicted in various states of assembly, including the receptacle 12 and the detonation apparatus 50, with pressurization cartridge 26 and cartridge housing 28, trigger assembly 52, including detonation pin 54, spring-loaded hammer 56, lever 58 (also commonly referred to as “spoon”), and hammer housing 60, and the first 70 and second 80 safety pins. As depicted particularly in FIG. 11A, the hammer housing 60 preferably includes a counter-threaded fastener 62 or other connection features to attach the detonation apparatus 50 to the receptacle 12, and a threaded fastener 64 or other connection features to attach the cartridge housing 28 and/or the pressurization cartridge 26 directly. Likewise, the cartridge housing 28 and pressurization cartridge 26 preferably include counter-threaded fasteners 44 or other connection features to connect the same to the detonation apparatus 50, and specifically to the hammer housing 60, in preferable embodiments, as shown in FIGS. 11A-B.

As depicted in FIG. 11B, the cartridge housing 28 is sized and shaped to securely hold the pressurization cartridge 26, in preferable embodiments, and the cartridge housing 28 preferably includes one or more apertures 42 that facilitate the release of the pressurized fluid 30 from the pressurization cartridge 26 into the receptacle 12 in a controlled and relatively uniform manner.

The pressurization cartridge 26 is placed into the cartridge housing 28, in preferable embodiments, and the pressurization cartridge 26 and/or cartridge housing 28 are attached to the hammer housing 60 of the trigger assembly 52 using threaded and counter-threaded fasteners 44, 64, as depicted in FIGS. 11A-B, or other connection features, as will be known to those of skill in the art. The detonation apparatus 50 is then connected to the receptacle 12 using the threaded and counter-threaded fasteners 22, 62 or other connection features, disposing the pressurization cartridge 26 and cartridge housing 28 substantially centrally within the receptacle 12, which is preferably prefilled with animal repellant for disbursement, as depicted in FIGS. 11C-D.

The detonation apparatus 50 is placed into its activation state by rotating the spring-loaded hammer 56 away from the detonation pin 54 and ensuring the detonation pin 54 is in its retracted position. The spring-loaded hammer 56 can then be retained in the active position temporarily by inserting the first safety pin 70 through the one or more receiving apertures 66 in the hammer housing 60 or by rotating the lever 58 down to the locking position. With the lever 58 in the locking position, the spring-loaded hammer 56 is prevented from rotating and striking the detonation pin 54, and the first safety pin 70 can then be inserted through the apertures 68 in the lever 58 and the apertures 66 in the hammer housing 60 to retain both the lever 58 in its locking position and the spring-loaded hammer 56 in its active position, in preferable embodiments including those depicted in FIG. 11C-D.

With the first safety pin 70 in place, the detonation apparatus 50 is now ready for use. To ensure the detonation apparatus 50 is not inadvertently activated, preferable embodiments of the first safety pin 70 include a handle portion 72 on one end and a plug 74 on the other, preferably made of rubber, silicone, or other plastics or appropriate materials, as will be known to those of skill in the art. The plug 74 is removably attached to the end 76 of the first safety pin 70 opposite the handle portion 72.

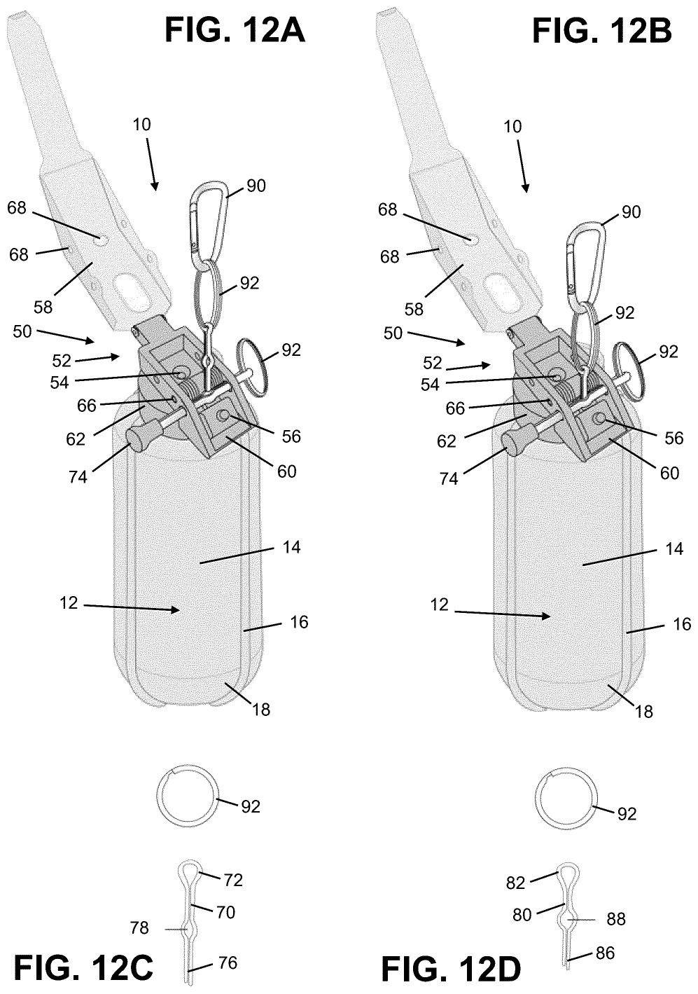

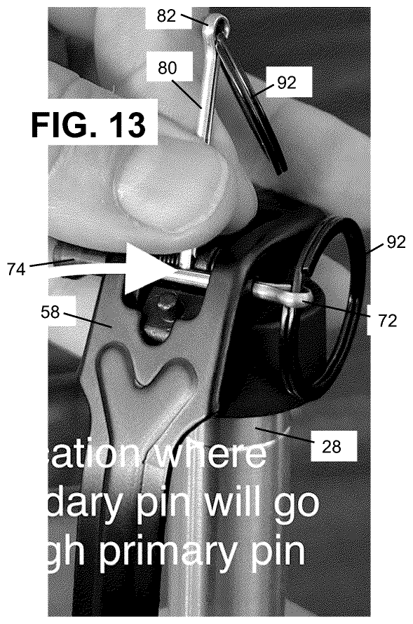

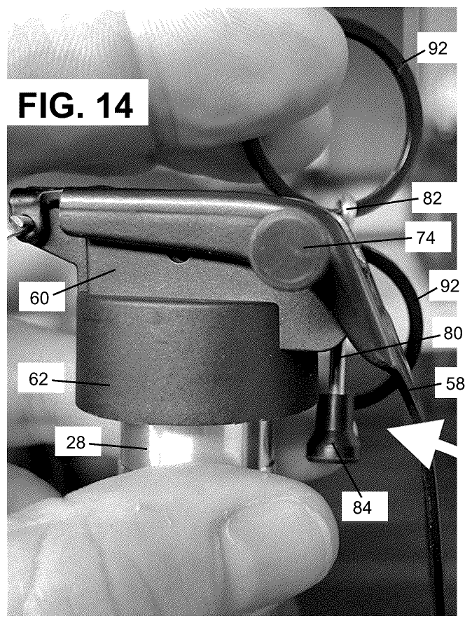

Preferable embodiments of the first safety pin 70 further include a substantially centrally located eyelet 78, as depicted in FIG. 12C. The eyelet 78 is preferably sized and positioned to receive the second safety pin 80 once inserted into the hammer housing 60. The circumference of the first safety pin 70 is preferably increased at the position of the eyelet 78, as depicted in FIG. 12C, with the increased circumference being large enough to create some resistance when that portion of the first safety pin 70 passes through the one or more apertures 66 in the hammer housing 60 and the one or more apertures 68 in the lever 58 but not being so large as to prevent the first safety pin 70 from passing through said apertures 58, 68, helping to prevent the inadvertent removal of the first safety pin 70.

The present invention preferably includes additional safety features to prevent inadvertent activation of the detonation apparatus 50. As depicted in FIG. 12D, one such additional safety feature is a second safety pin 80. The second safety pin 80 is preferably disposed in the detonation apparatus 50 in a position substantially perpendicular to that of the first safety pin 70, as depicted. The second safety pin 80, like the first safety pin 70, preferably includes a handle portion 82 at one end and a removeable plug 84 at the opposite end 86 as well as an eyelet 88, as depicted.

The second safety pin 80 operates by passing through one or more apertures 68 in the lever 58 and one or more apertures 66 hammer housing 60, respectively, as well as through the eyelet 78 in the first safety pin 70, as depicted in FIGS. 12A-B and 13. When fully installed, the second safety pin 80 preferably extends all the way through the hammer housing 60 and below, with a portion of the second safety pin 80 accessible from below the hammer housing 60 to attach the second safety pin's 80 removeable plug 84, as depicted specifically in FIG. 14.

In preferable embodiments of the second safety pin 80 that include an eyelet 88, the increased circumference of the second safety pin 80 at the eyelet's 88 location is preferably large enough to create some resistance when that portion of the second safety pin 80 passes through the one or more apertures 66 in the hammer housing 60, the one or more apertures 68 in the lever 58 and the eyelet 78 of the first safety pin 70 but not so large as to prevent the second safety pin 80 from passing through said apertures 66, 68 and eyelet 78 entirely, helping to prevent the inadvertent removal of the second safety pin 80. With the second safety pin 80 inserted and disposed through the eyelet 78 of the first safety pin 70, the first safety pin 70 cannot be removed unless and until the second safety pin 80 has been removed first, providing an additional safety feature to prevent the inadvertent activation of the detonation apparatus 50.

Once the receptacle 12 has been prefilled with animal repellant, the pressurization cartridge 26 has been installed and disposed within the receptacle 12, the detonation apparatus 50 has been placed into its activated state, and the dispersing device 10 is fully assembled using the threaded fasteners 22, 44, 62, 64 or other connection features, the device 10 is ready for operation and can be retained in the activation state indefinitely. When the user needs to use the animal repellant dispersing device 10 of the present invention, the user first must remove the second safety pin 80, in preferable embodiments, to free up the first safety pin 70.

As depicted in FIGS. 11 and 12, the second safety pin 80 is preferably provided with means, such as a carabiner 90 and/or ring 92, for attaching the device 10 to the user's person. The first safety pin 70 may be likewise equipped with a carabiner 90 and/or ring 92 to facilitate its removal. In such preferable embodiments, the second safety pin 80 can be removed in an emergency situation simply by yanking the device 10 away from the user's person, by which the second safety pin 80 is quickly removed from the detonation apparatus 50 and left hanging on the attached article of clothing, backpack, or the like.

With the second safety pin 80 removed, the user is now free to pull the first safety pin 70, release the lever 58, which rotates up and away from the spring-loaded hammer 56 allowing the spring-loaded hammer 56 to rotate to strike the detonation pin 54. Once struck, the detonation pin 54 travels toward and penetrates the pressurization cartridge 26, releasing the pressurized fluid 30 therefrom. The pressurized fluid 30 is then dispersed, through the one or more apertures 42 in the cartridge housing 28, in preferable embodiments, into the receptacle 12, increasing the pressure within the receptacle 12 to the point of rupture.

The user will preferably hold the lever 58 close to the shell after the first safety pin 70 has been pulled. Holding the lever 58 prevents the hammer 56 from rotating and driving detonation pin 54 into the CO2 or other pressurized gas cartridge 26. Once the user throws the device 10 or otherwise releases the lever 58, the hammer 56 is free to rotate and immediately strikes the detonation pin 54 into pressurization cartridge 26. From this point onward, there will be several seconds before the pressure builds within the receptacle 12 to a point of rupture. Upon rupturing, the animal repellant within the receptacle 12 is dispersed, preferably in a reasonably uniform manner, into the area where the device 10 rests. The receptacle 12 is designed with the one or more lengthwise ribs 16 and other features to help ensure the receptacle 12 ruptures in such a manner that the animal repellant is dispersed as a plume in the area rather than with a directed spray in a single direction. In some preferable embodiments, the sidewall 14 of the receptacle 12 is provided with a pineapple or honeycomb design to help ensure a plumed manner of release of the animal repellant, and such preferable designs may also release some relatively low-velocity shrapnel when the receptacle 12 ruptures, which may offer some additional deterrent to a wild animal in the area.

As those of skill in the art will appreciate, the present invention has been described with reference to particular embodiments and arrangements of parts, features, and the like, and it is not limited to these embodiments or arrangements. Indeed, modifications and variations will be ascertainable to those of skill in the art, all of which are inferentially and inherently included in these teachings.

What is claimed is:

1. A throwable animal repellant dispersing device, comprising:
a receptacle comprising an opening and a receptacle connection feature at a first lengthwise end and further comprising one or more ribs provided on a sidewall of the receptacle, the receptacle containing an animal repellant fluid;
a pressurization cartridge suspended at a substantially central location within the receptacle, the opening in the first lengthwise end being sized and shaped to receive the pressurization cartridge, the pressurization cartridge containing a pressurized fluid; and
a detonation apparatus comprising a detonation pin, a spring-loaded hammer, a lever, a hammer housing, and a first safety pin, the lever holding the spring-loaded hammer in an activated position, the first safety pin being removably insertable through one or more apertures in the lever and through one or more apertures in the hammer housing to prevent the lever from rotating at a hinge connecting the lever to the hammer housing and releasing the spring-loaded hammer to strike the detonation pin and puncture the pressurization cartridge, releasing the pressurized fluid into the receptacle.

2. The throwable animal repellant dispersing device of claim 1, wherein the first lengthwise end of the receptacle is curved to form a curved top and the receptacle further comprises a second lengthwise end that is curved to form a bottom of the receptacle, the bottom of the receptacle comprising an apex area forming a flat surface allowing the receptacle to rest in a standing position on the second lengthwise end.

3. The throwable animal repellant dispersing device of claim 1, the one or more ribs extending lengthwise along the sidewall of the receptacle, the one or more ribs operating to strengthen areas of sidewall to facilitate the release of the animal repellant fluid in a substantially uniform manner upon rupture of the receptacle due to the introduction of the pressurized fluid within the receptacle.

4. The throwable animal repellant dispersing device of claim 1, the one or more ribs comprising rupture lines creating a pineapple appearance covering the sidewall of the receptacle, the rupture lines operating to facilitate the release of the animal repellant fluid in a substantially uniform manner upon rupture of the receptacle due to the introduction of the pressurized fluid within the receptacle.

5. The throwable animal repellant dispersing device of claim 1, further comprising a cartridge housing comprising an open lengthwise end sized and shaped to receive the pressurization cartridge, the cartridge housing being sized and shaped to be inserted into the opening in the first lengthwise end of the receptacle, the cartridge housing further comprising a cartridge housing connection feature to removably connect the cartridge housing to the detonation apparatus.

6. The throwable animal repellant dispersing device of claim 5, the cartridge housing further comprising one or more apertures to manage the release of pressurized fluid from the pressurization cartridge into the receptacle.

7. The throwable animal repellant dispersing device of claim 1, the detonation apparatus further comprising one or more detonation apparatus connection features and the pressurization cartridge further comprising a cartridge connection feature, the one or more detonation apparatus connection features operating to connect to the receptacle connection feature and to the cartridge connection feature.

8. The throwable animal repellant dispersing device of claim 7, wherein the receptacle connection feature comprises a threaded fastening element, the cartridge connection feature comprises a threaded fastening element, and the one or more detonation apparatus connection features each comprises a counter-threaded fastening element.

9. The throwable animal repellant dispersing device of claim 1, further comprising a second safety pin, each of the first safety pin and second safety pin comprising a first end comprising a handle, a second end comprising a removable plug, and an eyelet located near a lengthwise center point thereof.

10. The throwable animal repellant dispersing device of claim 9, wherein the second safety pin is removably insertable through the one or more apertures in the lever, through the one or more apertures in the hammer housing, and through the eyelet in the first safety pin such that the second safety pin is substantially perpendicular to the first safety pin and prevents inadvertent removal of the first safety pin when inserted, the removeable plug of the first safety pin further protecting against the inadvertent removal of the first safety pin and the removeable plug of the second safety pin protecting against the inadvertent removal of the second safety pin.

11. A lower end receptacle of a throwable animal repellant dispersing device, comprising:
a first lengthwise end forming a curved top of the receptacle and comprising an opening sized and shaped to receive a pressurization cartridge;
a sidewall comprising one or more ribs;
a second lengthwise end forming a curved bottom of the receptacle and comprising an apex area forming a flat surface allowing the receptacle to rest in a standing position on the second lengthwise end.

12. The lower end receptacle of a throwable animal repellant dispersing device of claim 11, the one or more ribs extending lengthwise along the sidewall of the receptacle, the one or more ribs operating to strengthen areas of sidewall to facilitate the release of the animal repellant fluid in a substantially uniform manner upon rupture of the receptacle due to the introduction of the pressurized fluid within the receptacle.

13. The lower end receptacle of a throwable animal repellant dispersing device of claim 11, the one or more ribs comprising rupture lines creating a pineapple appearance covering the sidewall of the receptacle, the rupture lines operating to facilitate the release of the animal repellant fluid in a substantially uniform manner upon rupture of the receptacle due to the introduction of the pressurized fluid within the receptacle.

14. The lower end receptacle of a throwable animal repellant dispersing device of claim 11, the first lengthwise end of the lower end receptacle further comprising a threaded fastening element to connect the lower end receptacle to an upper end detonation apparatus.

15. An upper end detonation apparatus of a throwable animal repellant dispersing device, comprising:
a detonation pin operable to puncture a pressurization cartridge and release a pressurized fluid contained therein;
a spring-loaded hammer oriented to strike the detonation pin upon release of tension created in an associated spring;
a lever connected to a hammer housing by a hinge, the lever being operable to rotate relative to the hammer housing at the hinge, the lever operating to prevent the spring-loaded hammer from striking the detonation pin with the lever is held adjacent to the hammer housing, the lever comprising one or more apertures and the hammer housing comprising one or more apertures; and
a first safety pin removably insertable through the one or more apertures in the lever and through the one or more apertures in the hammer housing to prevent the lever from rotating away from the hammer housing and releasing the spring-loaded hammer to strike the detonation pin and puncture the pressurization cartridge.

16. The upper end detonation apparatus of a throwable animal repellant dispersing device of claim 15, further comprising one or more threaded fastening elements to connect the upper end detonation apparatus to a lower end receptacle, to the pressurization cartridge, and to a cartridge housing comprising an open lengthwise end sized and shaped to receive the pressurization cartridge.

17. The upper end detonation apparatus of a throwable animal repellant dispersing device of claim 16, the cartridge housing further comprising one or more apertures to manage the release of pressurized fluid from the pressurization cartridge.

18. The upper end detonation apparatus of a throwable animal repellant dispersing device of claim 15, the first safety pin comprising a first end comprising a handle, a second end comprising a removable plug, and an eyelet located near a lengthwise center point of the first safety pin, the removeable plug protecting against the inadvertent removal of the first safety pin from the upper end detonation apparatus.

19. The upper end detonation apparatus of a throwable animal repellant dispersing device of claim 18, further comprising a second safety pin comprising a first end comprising a handle, a second end comprising a removable plug, and an eyelet located near a lengthwise center point of the second safety pin, the removeable plug protecting against the inadvertent removal of the second safety pin from the upper end detonation apparatus.

20. The upper end detonation apparatus of a throwable animal repellant dispersing device of claim 19, wherein the second safety pin is removably insertable through the one or more apertures in the lever, through the one or more apertures in the hammer housing, and through the eyelet in the first safety pin such that the second safety pin is substantially perpendicular to the first safety pin and prevents inadvertent removal of the first safety pin when inserted.
